(19) United States
(12) Patent Application Publication
(10) Pub. No.: US 2012/0292123 A1
(43) Pub. Date: Nov. 22, 2012

(54) Splash cover mounting structure

(75) Inventor: Satoshi MORITA, Hamamatsu (JP)

(73) Assignee: SUZUKI MOTOR CORPORATION, Hamamatsu (JP)

(21) Appl. No.: 13/475,665

(22) Filed: May 18, 2012

(30) Foreign Application Priority Data
May 20, 2011 (JP) 2011-114224

(51) Int. Cl. B62D 27/06

(52) U.S. Cl. 180/69.1

(57) ABSTRACT

A splash cover mounting structure is provided that can achieve cost saving and weight reduction by reduction of fastening members such as clips, and will not compromise the assembly workability. The configuration of a splash cover mounting structure (cover mounting structure) according to the invention includes a splash cover including a first fixation surface that can be fixed laterally to an engine compartment of an automobile and a second fixation surface disposed below the engine compartment; and an under cover for covering a bottom of the engine compartment, wherein the second fixation surface includes: a provisional fixation pawl that projects upward and can be provisionally fixed to a frame member of the automobile located below the engine compartment; and bottom fixation holes that can be used to fasten the splash cover to the frame member together with the under cover.

### CROSS-REFERENCE TO RELATED APPLICATIONS

This application is based upon and claims the benefit of priority from the prior Japanese Patent Application No. 2011-114224, filed on May 20, 2011, the entire contents of which are incorporated herein by reference.

### BACKGROUND OF THE INVENTION

I. Field of the Invention

The present invention relates to a splash cover mounting structure disposed laterally to the engine compartment of an automobile.

II. Description of the Related Art

A splash cover is provided laterally to the engine compartment of an automobile in order to prevent entry of pebbles, sand, and the like splashed by the tires while the automobile is travelling. For example, Japanese Patent Laid-open Publication No. Sho58-61075 and Japanese Patent Laid-open Publication No. 2001-180531 disclose conventional techniques for such a splash cover.

As disclosed in Japanese Patent Laid-open Publication No. 2001-180531, usually, a splash cover is put into contact with the vehicle body side wall (vehicle body side panel) from outside, and is fixed using fastening members such as clips. Further, the splash cover is put into contact with a frame member (the so-called chassis) from below, and is also fixed to the frame member, which is rigid, using fastening members such as clips. Here, an under cover (see Japanese Patent Laid-open Publication No. Heill-348833) or the like for covering the bottom of the engine compartment is also fixed to the rigid frame member.

In recent years, there has been a need for a further cost saving (reduction in the number of assembling steps) and a radical weight reduction down to the order of 1 g for automobiles. To attain this, there is also room for improvement in the method for assembling the splash cover and the under cover. However, it would be inefficient to make the assembling operation difficult even if cost saving and weigh reduction can be achieved by reduction of the number of assembling steps and the number of components. Adopting a configuration that can only be assembled by a skilled worker would rather increase the working hours, making it impossible to save costs.

The present invention has been achieved in view of the foregoing problem, and it is an object of the invention to provide a splash cover mounting structure that can achieve cost saving and weight reduction by reduction of the number of fastening members such as clips, and will not compromise the assembly workability.

### SUMMARY OF THE INVENTION

In order to solve the foregoing problem, a typical configuration of a splash cover mounting structure according to the present invention includes: a splash cover including a first fixation surface that can be fixed laterally to an engine compartment of an automobile and a second fixation surface disposed below the engine compartment; and an under cover for covering a bottom of the engine compartment, wherein the second fixation surface of the splash cover includes: a provisional fixation pawl that projects upward and can be provisionally fixed to a frame member of the automobile located below the engine compartment; and bottom fixation holes that can be used to fasten the splash cover to the frame member together with the under cover.

With this configuration, the second fixation surface of the splash cover includes the provisional fixation pawl. Accordingly, at the time of fixing the first fixation surface to the vehicle body side wall on the production line before assembly of a fender lining, the second fixation surface can be provisionally fixed to the frame member using the provisional fixation pawl. Provisionally fixing the second fixation surface allows the splash cover to be easily fastened to the frame member together with the under cover. Accordingly, it is possible to reduce the number of fastening members such as clips without compromising the assembly workability, thus achieving cost saving and weigh reduction.

It is preferable that the provisional fixation pawl is substantially frustum-shaped, having an upper face and a side face, and that the side face is provided with flexible fitting pawls that can be fitted to an edge of provisional fixation holes formed in the frame member. This allows the provisional fixation pawl to be easily inserted into the provisional fixation hole, and therefore, the second fixation surface can be provisionally fixed to the frame member in a suitable manner.

Preferably, the provisional fixation pawl is covered by the under cover from below. With this configuration, there is no possibility that the provisional fixation pawl is visible, and therefore, an aesthetic appearance can be ensured.

According to the present invention, it is possible to provide a splash cover mounting structure that can achieve cost saving and weight reduction by reduction of the number of fastening members such as clips, and will not compromise the assembly workability.

### BRIEF DESCRIPTION OF THE DRAWINGS

FIGS. 1A and 2A are diagrams showing a splash cover used for a splash cover mounting structure according to an embodiment of the present invention.

FIGS. 2A and 2B are diagrams showing the provisional fixation pawl of the splash cover in FIGS. 1A and 2A.

FIG. 3 is a diagram showing the splash cover mounting structure according to an embodiment of the present invention.

FIG. 4 is a diagram showing FIG. 3 from which the splash cover and the under cover have been removed.

FIG. 5 is a diagram showing the splash cover mounting structure in FIG. 3 as viewed from below.

FIG. 6 is a cross-sectional view taken along the arrows A-A in FIG. 5.

FIGS. 7A to 7C are diagrams showing other examples of the provisional fixation hole of the suspension frame in FIG. 6.

### DETAILED DESCRIPTION OF THE INVENTION

Hereinafter, a preferred embodiment of the present invention will be described in detail with reference to the accompanying drawings. The dimensions, materials, and other specific numerical values described in this embodiment are merely examples for facilitating the understanding of the present invention, and are not to be construed as limiting the invention unless otherwise stated. It should be noted that elements constituting substantially identical functions and configurations are denoted by identical reference numerals in the present specification and the drawings, and hence redundant description has been omitted. Also, illustration of elements that are not directly relevant to the present invention has been omitted.

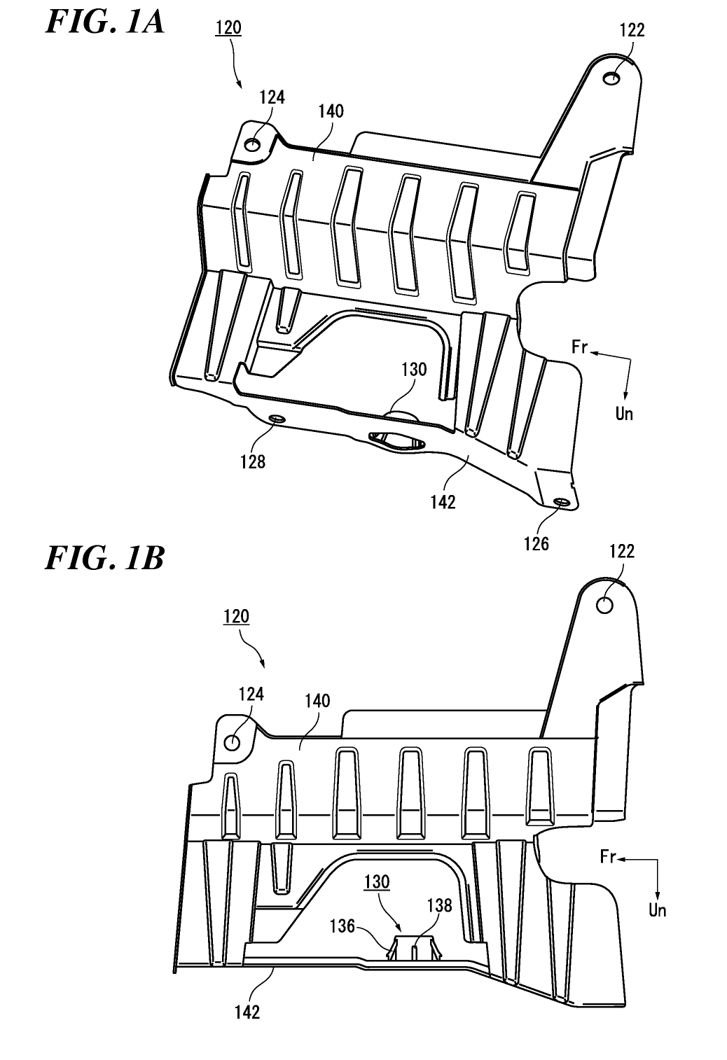

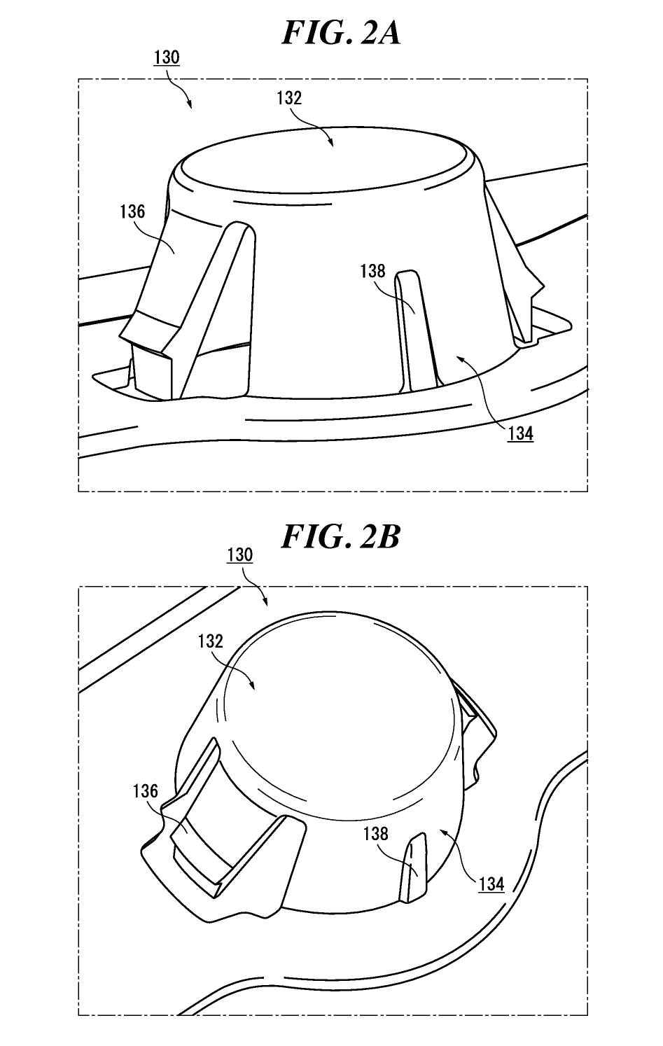

FIGS. 1A and 2A are diagrams showing a splash cover 120 used for a splash cover mounting structure according to an embodiment of the present invention. FIG. 1A is a perspective view of the splash cover 120, and FIG. 1B is a side view of the splash cover 120. In FIGS. 1A and 2B, the arrow Fr denotes the vehicle front side and the arrow Un denotes the vehicle underside.

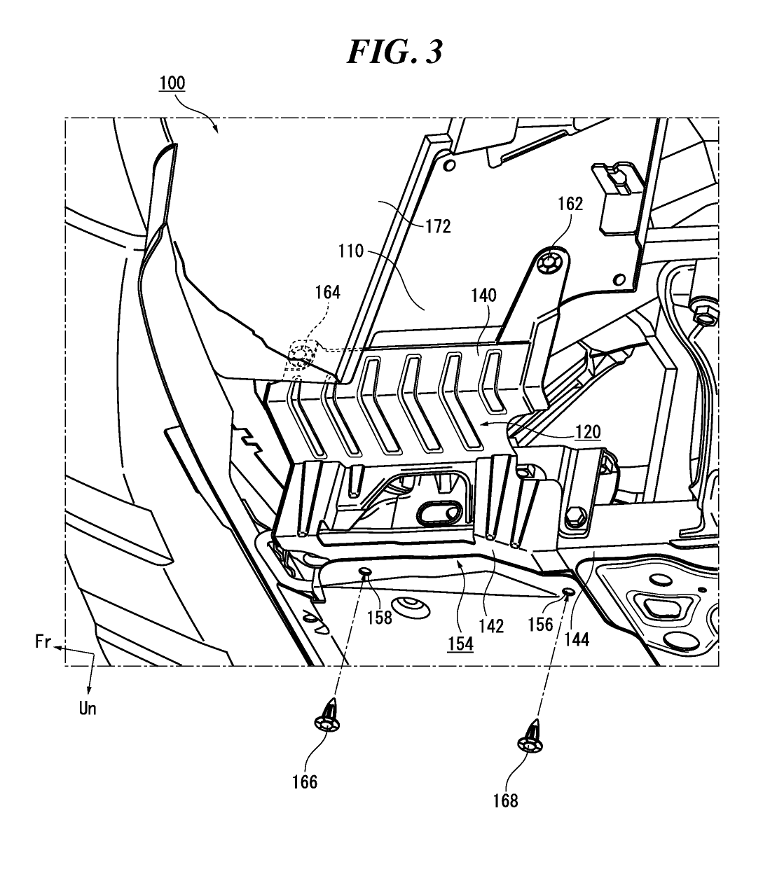

As shown in FIGS. 1A and 1B, the splash cover 120 includes a first fixation surface 140 that is put into contact with a vehicle body side wall 110 (see FIG. 3, for example) from outside and a second fixation surface 142 that is put into contact with a suspension frame 144 (see FIG. 3, for example) serving as a frame member from below, and overall, the splash cover 120 substantially has a “W” shape. The first fixation surface 140 is provided with upper fixation holes 122 and 124, and the second fixation surface 142 is provided with bottom fixation holes 126 and 128. The second fixation surface 142 is also provided with a provisional fixation pawl 130 projecting upward.

FIGS. 2A and 2B are diagrams showing the provisional fixation pawl 130 of the splash cover 120 in FIGS. 1A and 2B. As shown in FIGS. 2A and 2B, the provisional fixation pawl 130 includes an upper face 132 and a side face 134, and overall, it substantially has the shape of a frustum of a cone. Its side face 134 is provided with two fitting pawls 136, only one of which is denoted by a reference numeral in FIGS. 2A and 2B, facing away from each other. The side face 134 is also provided with two ribs 138, only one of which is denoted by a reference numeral in FIGS. 2A and 2B, facing away from each other. The fitting pawls 136 are cantilevered in the vicinity of the upper face 132, and thus their flexibility is ensured and they can be easily bent inward.

In general, the splash cover 120 is produced by resin molding. The provisional fixation pawl 130 provided at the splash cover 120 can be formed by resin molding together with the body portion of the splash cover 120, and therefore will not result in a cost increase.

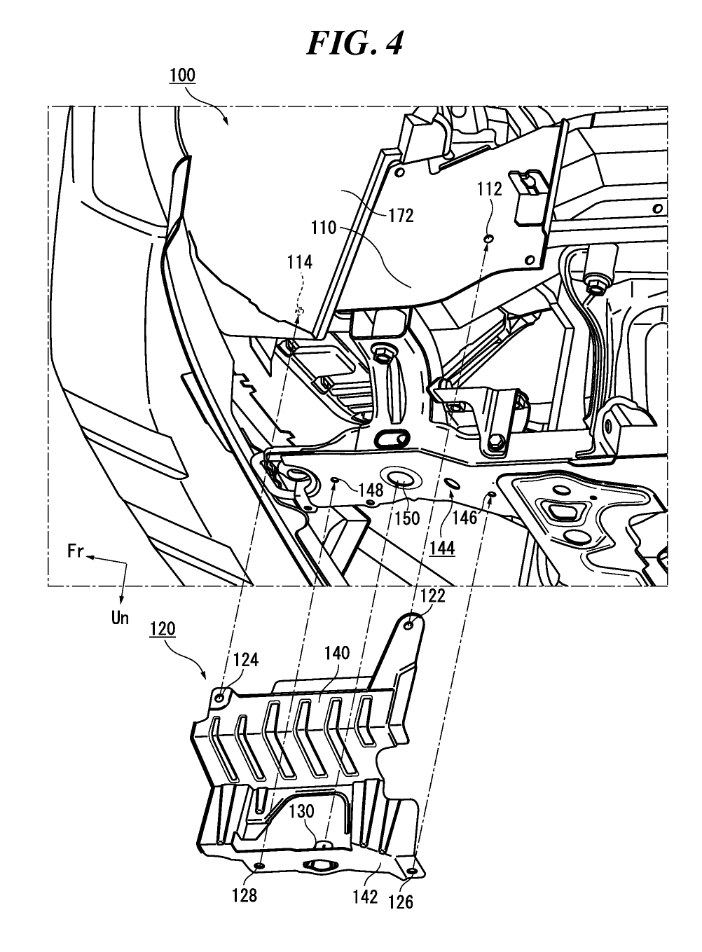

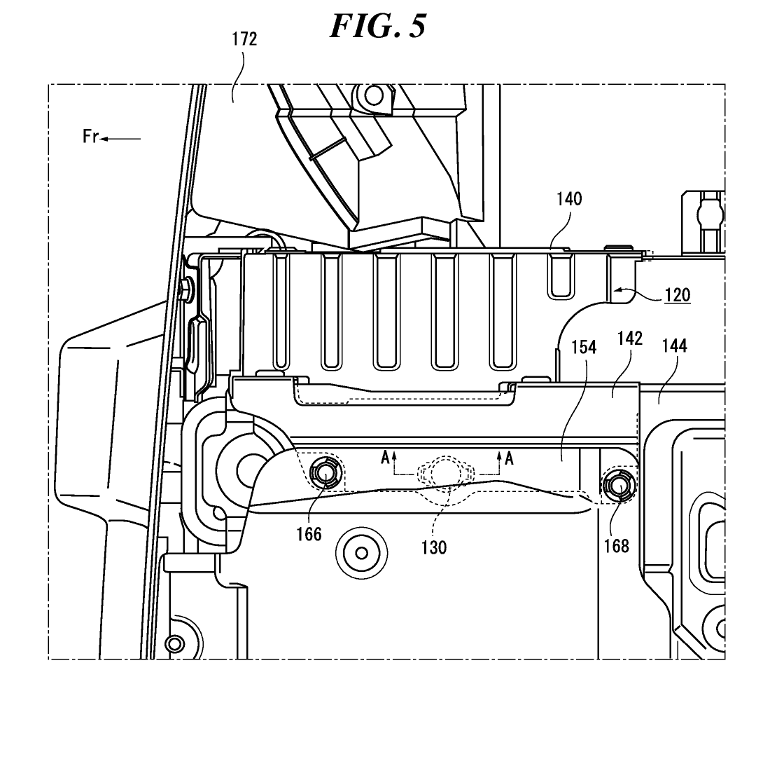

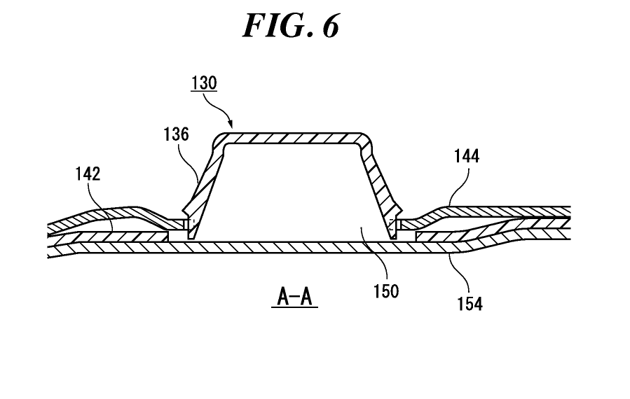

FIG. 3 is a diagram showing a splash cover mounting structure (hereinafter, referred to as the “cover mounting structure 100”) according to an embodiment of the present invention. FIG. 4 is a diagram showing FIG. 3 from which the splash cover 120 and the under cover 154 have been removed. FIG. 5 is a diagram showing the cover mounting structure 100 in FIG. 3 as viewed from below. FIG. 6 is a cross-sectional view taken along the arrows A-A in FIG. 5.

As shown in FIG. 3, the splash cover 120 described above is disposed laterally to the engine compartment of an automobile. In order to achieve cost saving and weight reduction, this embodiment adopts a configuration in which the splash cover 120 and the under cover 154 are fastened together to the suspension frame 144. More specifically, the bottom fixation holes 126 and 128 of the splash cover 120 and fixation holes 156 and 158 formed on the side of the under cover 154 covering the bottom of the engine compartment are fastened together with clips 166 and 168 to fixation holes 146 and 148 of the suspension frame 144. Accordingly, the fastening several components together as in this embodiment can reduce the number of fastening members such as clips, compared with the case where the splash cover 120 and the under cover 154 are separately fixed to the suspension frame 144.

As such, according to this embodiment, the configuration of fastening several components together can reduce the number of fastening members such as clips, thus achieving cost saving and weight reduction. However, at the production site of automobiles, the splash cover 120 requires the first fixation surface 140 to be fixed to the vehicle body side wall 110 (body side panel) located laterally to the engine compartment on the production line, prior to assembly of a fender lining 172. The first fixation surface 140 is fixed to the vehicle body side wall 110 by insertion of clips 162 and 164 into the upper fixation holes 122 and 124 and the fixation holes 112 and 114 of the vehicle body side wall 110. On the other hand, the under cover 154 will not be assembled until after the completion inspection of the vehicle, and may also be expected to be removed and reattached during subsequent inspection and maintenance of the vehicle.

Therefore, if the splash cover 120 and the side of the under cover 154 are fastened together to the suspension frame 144, then the splash cover 120 is fixed only to the vehicle body side wall until after the completion inspection (i.e., the splash cover 120 is suspended only by the vehicle body side wall and is thus dangling). Accordingly, the fixation holes for fastening the dangling splash cover 120 and the side of the under cover 154 together need to be aligned at the time of actually fastening these parts together after the completion inspection. However, there may be cases where the positions of the corresponding fixation holes may not be aligned, making the operation difficult. In particular, this operation is expected to be performed by one person, and therefore, there is a need for an improvement strategy that enables the operation to be easily performed by one person. Since the under cover 154 may be expected to be removed and reattached also during the inspection and maintenance of the vehicle, care must be taken especially not to reduce the ease of maintenance.

Therefore, this embodiment adopts the splash cover 120 including the provisional fixation pawl 130, and the provisional fixation pawl 130 projecting upward from the second fixation surface 142 is inserted into a provisional fixation hole 150 (see FIG. 4) formed in the suspension frame 144 at the time of fixing the first fixation surface 140 to the vehicle body side wall 110 on the production line. Doing so causes the fitting pawls 136 to be fitted to the edge of the provisional fixation hole 150 of the suspension frame 144 as shown in FIG. 6.

The positioning in the front-rear direction and the up-down direction of the vehicle is achieved by the fitting pawls 136 being fitted to the edge of the provisional fixation hole 150. Further, the positioning in the width direction of the vehicle is achieved by the ribs 138 coming into contact against the edge of the provisional fixation hole 150. Accordingly, a state where the bottom fixation holes 126 and 128 of the second fixation surface 142 and the fixation holes 146 and 148 of the suspension frame 144 are aligned can be ensured from the time of fixation of the first fixation surface 140 to the vehicle body side wall 110. This allows the operation of fastening the under cover 154 together with other components after the completion inspection to be performed easily.

As shown in FIG. 5, after the operation of fastening several components together, the provisional fixation pawl 130 of the second fixation surface 142 is covered by the under cover 154 as viewed from below. Accordingly, there is no possibility that the provisional fixation pawl 130 is visible, and therefore, an aesthetic appearance can be ensured.

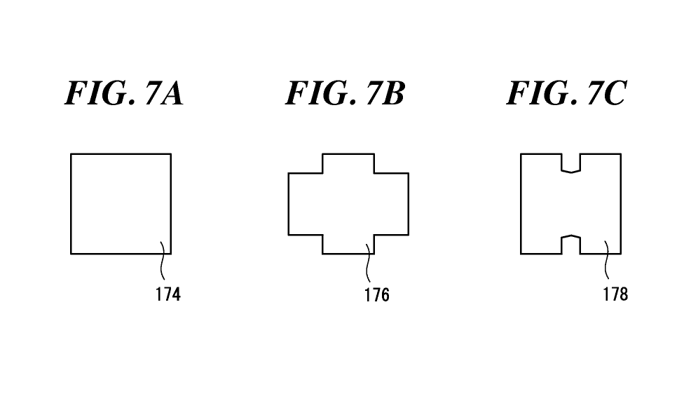

FIGS. 7A to 7C are diagrams showing other examples (provisional fixation holes 174, 176, 178) of the provisional fixation hole 150 of the suspension frame 144 in FIG. 6. Although the provisional fixation hole 150 has a substantially circular shape in FIG. 4, it is possible to adopt a provisional fixation hole 174 having a substantially square shape as shown in FIG. 7A. The use of the provisional fixation hole 174 having a substantially square shape makes it possible to prevent the provisional fixation pawl 130 from rotating. It is also possible to adopt provisional fixation holes 176 and 178, which are irregularly shaped holes, as shown in FIGS. 7B and 7C. When the provisional fixation holes 174, 176, and 178 shown in FIGS. 7A to 7C are adopted, the provisional fixation pawl 130 may be substantially frustum-shaped (for example, substantially the shape of a frustum of a quadrangular pyramid) conforming to each of the shapes of the provisional fixation holes 174, 176, and 178.

A preferred embodiment of the present invention has been described above in detail with reference to the accompanying drawings. With the cover mounting structure 100 described above, the splash cover 120, which needs to be first fixed to the vehicle body side wall 110 on the production line, and the under cover 154, which needs to be assembled after the completion inspection, can be fastened together in a suitable manner. Accordingly, it is possible to reduce the number of fastening members such as clips without compromising the assembly workability, thus achieving cost saving and weight reduction.

It should be appreciated that the present invention is not limited to the embodiment shown below. It will be apparent for a person skilled in the art that various modifications and variations may be made within the scope of the invention as defined in the appended claims, and those modifications and variations should be understood to be included within the technical scope of the present invention.

The present invention is applicable to a splash cover mounting structure disposed laterally to the engine compartment of an automobile.

What is claimed is:

1. A splash cover mounting structure comprising:
a splash cover including a first fixation surface that can be fixed laterally to an engine compartment of an automobile and a second fixation surface disposed below the engine compartment; and
an under cover for covering a bottom of the engine compartment;
wherein the second fixation surface of the splash cover comprises:
a provisional fixation pawl that projects upward and can be provisionally fixed to a frame member of the automobile located below the engine compartment; and
bottom fixation holes that can be used to fasten the splash cover to the frame member together with the under cover.

2. The splash cover mounting structure according to claim 1, wherein:
the provisional fixation pawl is substantially frustum-shaped, having an upper face and a side face, and the side face is provided with flexible fitting pawls that can be fitted to an edge of provisional fixation holes formed in the frame member.

3. The splash cover mounting structure according to claim 1, wherein the provisional fixation pawl is covered by the under cover from below.
